(19) United States
(12) Patent Application Publication
(10) Pub. No.: US 2019/0035227 A1
(43) Pub. Date: Jan. 31, 2019

(54) BLACKJACK OFFERING ENHANCED PAYOUT

(71) Applicants: Megan KENNEDY, Umhlanga (ZA); Nicole MARKIE, Hout Bay (ZA); Stephen Paul DIVERSI, Hout Bay (ZA)

(72) Inventor: Robin David KENNEDY, Umhlanga (ZA)

(21) Appl. No.: 16/071,028

(22) PCT Filed: Jan. 11, 2017
(86) PCT No.: PCT/ZA2017/050002

§ 371 Date: Jul. 18, 2018

(30) Foreign Application Priority Data
Jan. 19, 2016 (ZA) 2016/00395

(51) Int. Cl. G07F 17/32

(52) U.S. Cl. CPC G07F 17/3293; G07F 17/3244; G07F 17/3267

(57) ABSTRACT

The invention provides a method and apparatus for providing a Blackjack player with an additional bet when betting on a conventional blackjack, said method including—providing for a bet by a Blackjack player in addition to the standard blackjack bet, —designating enhanced payouts for a two card blackjack which are much higher than the standard payouts for a blackjack, and dealing the player two cards from a set of gaming cards selected to have from 1 to 8 decks of 52 cards each after the player has placed bets on a conventional blackjack and the additional enhanced payout blackjack. The invention extends to providing for a blackjack betting layout on a table or a sheet, which layout has in addition to a standard blackjack layout having conventional blackjack bet placement areas one or more additional bet placement areas adjacent the conventional bet placement areas so that a bet may be made by a Blackjack player in addition to the standard blackjack bet.

### FIELD OF THE INVENTION

The invention relates to the game of Blackjack and to a method and apparatus for enhancing the payout possibility.

### BACKGROUND TO THE INVENTION

According to Wikipedia, Blackjack is the most widely played casino banking game in the world. Blackjack is a comparing card game between a player and dealer, meaning players compete against the dealer but not against other players. It is played with one or more decks of 52 cards. The object of the game is to beat the dealer in one of the following ways:
Get 21 points on the player's first two cards (called a blackjack), without a dealer blackjack;
Reach a final score higher than the dealer without exceeding 21; or
Let the dealer draw additional cards until his or her hand exceeds 21.

The player or players are dealt a two-card hand and add together the value of their cards. Face cards (kings, queens, and jacks) are counted as ten points. A player and the dealer can count an ace as 1 point or 11 points. All other cards are counted as the numeric value shown on the card. After receiving their first two cards, players have the option of getting a “hit”, or taking an additional card. In a given round, the player or the dealer wins by having a score of 21 or by having the higher score that is less than 21. Scoring higher than 21 (called “busting” or “going bust”) results in a loss. A player may win by having any final score equal to or less than 21 if the dealer busts. If a player holds an ace valued as 11, the hand is called “soft”, meaning that the player cannot go bust by taking an additional card; 11 plus the value of any other card will always be less than or equal to 21. Otherwise, the hand is “hard”.

The dealer must hit until the cards total 17 or more points. (At many tables the dealer also hits on a “soft” 17, i.e. a hand containing an ace and one or more other cards totaling six.) Players win by not busting and having a total higher than the dealer's. The dealer loses by busting or having a lesser hand than the player who has not busted. If the player and dealer have the same total, this is called a “push”, and the player typically does not win or lose money on that hand.

Typically a player getting a Blackjack wins 3:2 and other winning hands pay at 1:1, but other odds are also used such as 6:5, and the like usually linked to the number of decks being played.

Many blackjack tables offer a side bet on various outcomes including:
Player hand and dealer's up card sum to 19, 20, or 21 (“Lucky Lucky”)
Player initial hand is a pair (“Perfect pairs”)
Player initial hand is suited, suited and connected, or a suited K-Q (“Royal match”)
Player initial hand plus dealer's card makes a flush, straight, or three-of-a-kind poker hand (“21+3”)
Player initial hand totals 20 (“Lucky Ladies”)
Dealer upcard is in between the value of the players two cards (“In Bet”)
First card drawn to the dealer will result in a dealer bust (“Bust It!”)
One or both of the players cards is the same as the dealers card (“Match the Dealer”)
Player allowed to make optional second hand, and effectively receive the hand of 10,8, or 18 without drawings cards (“Instant 18”)

The side wager is typically placed in a designated area next to the box for the main wager. A player wishing to wager on a side bet is usually required to place a wager on blackjack. Some games require that the blackjack wager should equal or exceed any side bet wager. A non-controlling player of a blackjack hand is usually permitted to place a side bet regardless of whether the controlling player does so.

The house edge for conventional side bets is generally far higher than for the blackjack game itself.

The inventor has identified a need for a method and an apparatus for providing a Blackjack player with an additional bet when wagering on a blackjack, which additional bet provides for sufficiently high odds if a player wins to both reward the player and encourage the player to place these additional bets.

### SUMMARY OF THE INVENTION

According to a first aspect of the invention, there is provided a method for providing a Blackjack player with an additional or side bet when betting on a conventional blackjack, said method including:
providing for a bet by a Blackjack player in addition to the standard blackjack bet;
designating enhanced payouts for a two card blackjack which are much higher than the standard payouts for a blackjack; and
dealing cards to the player after the player has placed bets on a conventional blackjack and the additional enhanced payout blackjack.

The enhanced payout may be enhanced to 40-1 for a same suit two card blackjack.

The enhanced payout may be enhanced to 15-1 for a same colour but different suits two card blackjack.

The enhanced payout may be enhanced to 10-1 for a different suit and different colour two card blackjack.

The enhanced payout may be payable to a winner in addition to the conventional blackjack payout, provided the player placed the additional bet prior to a first card being dealt.

According to a second aspect of the invention, there is provided a method and apparatus for providing a Blackjack player with an additional bet when betting on a conventional blackjack, said method including:
providing for a bet by a Blackjack player in addition to the standard blackjack bet;
designating enhanced payouts for a two card blackjack which are much higher than the standard payouts for a blackjack; and
dealing the player two cards from a set of gaming cards selected to have from 1 to 8 decks of 52 cards each after the player has placed bets on a conventional blackjack and the additional enhanced payout blackjack.

The enhanced payout may be enhanced to 40-1 where the first two cards dealt to a player are a same suit two card blackjack.

The enhanced payout may be enhanced to 15-1 where the first two cards dealt to a player are for a same colour but different suits two card blackjack.

The enhanced payout may be enhanced to 10-1 where the first two cards dealt to a player are for a different suit and different colour two card blackjack.

According to a third aspect of the invention, there is provided a method and apparatus for providing a Blackjack player with an additional bet when betting on a conventional blackjack, said method including:
providing for a blackjack betting layout on a table or a sheet, which layout has in addition to a standard blackjack layout having conventional blackjack bet placement areas one or more additional bet placement areas adjacent the conventional bet placement areas so that a bet may be made by a Blackjack player in addition to the standard blackjack bet;
designating enhanced payouts for a two card blackjack which are much higher than the standard payouts for a blackjack; and
dealing the player two cards from a set of gaming cards selected to have from 1 to 8 decks of 52 cards each after the player has placed bets on a conventional blackjack and the additional enhanced payout blackjack.

The sheet may be a sheet of material, plastics, cardboard, or the like.

### DESCRIPTION OF THE FIGURE

FIG. 1 shows a layout of a black jack table substantially in accordance with the invention.

### DESCRIPTION OF AN EMBODIMENT OF THE INVENTION

The invention will now be described, by way of non-limiting examples only, with reference to the schematic drawing of a Blackjack table layout.

In the example that follows, the enhanced payout Blackjack method and apparatus, is referred to be the name Blackjack's Better™ which is a phrase coined by the applicant and for which trade mark applications have been filed in some countries.

Blackjack's Better is a variation of the standard Blackjack game that allows the player to place an additional bet to cover the possibility of the hand dealt containing a blackjack.

It is important that the dealer offers this additional bet to the players before the commencement of each and every new hand.

The Layout

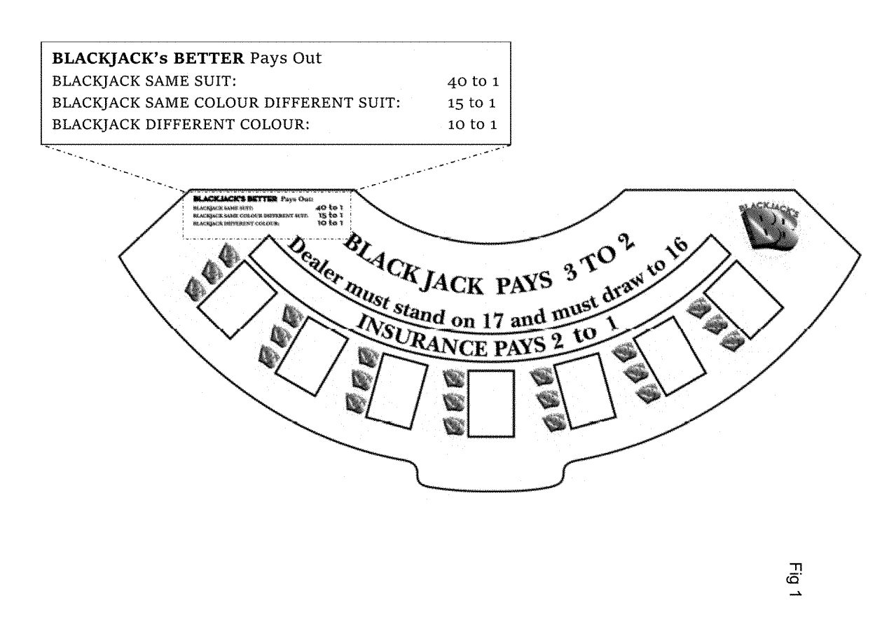

The table layout, as shown in the schematic diagram FIG. 1 at the end of the specification, will be similar to the normal Blackjack layout with seven or nine bet boxes and up to three “Blackjack's Better” betting areas per box, printed/embroidered on the layout as an extension to the normal betting boxes.

Placing a Blackjack's Better

A player may place a Blackjack's Better on any box on which the player has placed a blackjack wager before any cards in the round of play are dealt. The Blackjack's is Better must be within the limits of the minimum and maximum signage displayed on the table.

Dealing the Cards

When the initial two cards have been dealt, the dealer will remove all losing Blackjack's Better bets, working from right to left and then pay any winning bets before any further cards are dealt.

Winning Hands

Blackjack Same Suit

Should the first two cards dealt to a box be a blackjack consisting of two cards of the same suit, the winning bet will be paid at 40 to 1. The hand will then continue as per standard Blackjack procedures.

Blackjack Same Colour

Should the first two cards dealt to a box be a blackjack consisting of two cards of the same colour but a different suit the winning bet will be paid at 15 to 1. The hand will then continue as per standard Blackjack procedures.

Blackjack Different Colour

Should the first two cards dealt to a box be a blackjack consisting of two cards of a different colour the winning bet shall be paid at 10 to 1. The hand will then continue as per standard Blackjack procedures.

Pay-Outs of the various combinations of Blackjack's Better are as follows:

Blackjack same suit: 40 to 1

Blackjack same colour, different suit: 15 to 1

Blackjack different colour: 10 to 1

Definitions

Blackjack same suit: the first two cards dealt to a box consisting of an ace and any other card that has the value of ten, i.e. Ten, Jack, Queen or King (both the ace and the card having the value of ten must be of the same suit)

Blackjack same colour: the first two cards dealt to a box consisting of an ace and any other card that has the value of ten, i.e. Ten, Jack, Queen or King (both the ace and the card having the value of ten must be of the same colour, either both red or both black)

Blackjack different colour: the first two cards dealt to a box consisting of an ace and any other card that has the value of ten, i.e. Ten, Jack, Queen or King (the ace and the card having the value of ten must be of a different colour i.e. one red and one black)

The return to player and house advantage calculations for games dealt using from one to six decks are as follows:

BLACKJACK
SIDEBET

| | |
|---|---|
| Decks | 6 |
| Cards | 312 |
| Aces | 24 |
| Tens | 96 |

| | Probability | Pay-out | Return | RTP |
|---|---|---|---|---|
| BJ mixed colour | 0.02374 | 10 | 11 | 0.26119 |
| BJ same colour | 0.01187 | 15 | 16 | 0.18996 |
| different suit | | | | |
| BJ same suit | 0.01187 | 40 | 41 | 0.48677 |
| | 0.04749 | | | 93.79% |
| House Advantage % | 6.21% | | | |
| Avg # hands per hit | 21.1 | | | |

BLACKJACK
SIDEBET

| | |
|---|---|
| Decks | 5 |
| Cards | 260 |
| Aces | 20 |
| Tens | 80 |

| | Probability | Pay-out | Return | RTP |
|---|---|---|---|---|
| BJ mixed colour | 0.02374 | 10 | 11 | 0.26119 |
| BJ same colour | 0.01187 | 15 | 16 | 0.18996 |
| different suit | | | | |
| BJ same suit | 0.01188 | 40 | 41 | 0.48708 |
| | 0.04750 | | | 93.82% |
| House Advantage % | 6.18% | | | |
| Avg # hands per hit | 21.1 | | | |

BLACKJACK
SIDEBET

| | |
|---|---|
| Decks | 4 |
| Cards | 208 |
| Aces | 16 |
| Tens | 64 |

| | Probability | Pay-out | Return | RTP |
|---|---|---|---|---|
| BJ mixed colour | 0.02374 | 10 | 11 | 0.26119 |
| BJ same colour | 0.01187 | 15 | 16 | 0.18996 |
| different suit | | | | |
| BJ same suit | 0.01189 | 40 | 41 | 0.48755 |
| | 0.04751 | | | 93.87% |
| House Advantage % | 6.13% | | | |
| Avg # hands per hit | 21.0 | | | |

BLACKJACK
SIDEBET

| | |
|---|---|
| Decks | 3 |
| Cards | 156 |
| Aces | 12 |
| Tens | 48 |

| | Probability | Pay-out | Return | RTP |
|---|---|---|---|---|
| BJ mixed colour | 0.02374 | 10 | 11 | 0.26119 |
| BJ same colour | 0.01187 | 15 | 16 | 0.18996 |
| different suit | | | | |
| BJ same suit | 0.01191 | 40 | 41 | 0.48834 |
| | 0.04753 | | | 93.95% |
| House Advantage % | 6.05% | | | |
| Avg # hands per hit | 21.0 | | | |

BLACKJACK
SIDEBET

| | |
|---|---|
| Decks | 2 |
| Cards | 104 |
| Aces | 8 |
| Tens | 32 |

| | Probability | Pay-out | Return | RTP |
|---|---|---|---|---|
| BJ mixed colour | 0.02374 | 10 | 11 | 0.26119 |
| BJ same colour | 0.01187 | 15 | 16 | 0.18996 |
| different suit | | | | |
| BJ same suit | 0.01195 | 40 | 41 | 0.48992 |
| | 0.04757 | | | 94.11% |
| House Advantage % | 5.89% | | | |
| Avg # hands per hit | 21.0 | | | |

BLACKJACK
SIDEBET

| | |
|---|---|
| Decks | 1 |
| Cards | 52 |
| Aces | 4 |
| Tens | 16 |

| | Probability | Pay-out | Return | RTP |
|---|---|---|---|---|
| BJ mixed colour | 0.02374 | 10 | 11 | 0.26119 |
| BJ same colour | 0.01187 | 15 | 16 | 0.18996 |
| different suit | | | | |
| BJ same suit | 0.01207 | 40 | 41 | 0.49472 |
| | 0.04768 | | | 94.59% |
| House Advantage % | 5.41% | | | |
| Avg # hands per hit | 21.0 | | | |

It is an advantage of the invention as illustrated that players can win larger amounts with a blackjack while maintaining legally compliant house advantage.

1. A method and apparatus for providing a Blackjack player with an additional bet when betting on a conventional blackjack, said apparatus and method including:
providing for a bet by a Blackjack player in addition to the standard blackjack bet;
designating enhanced payouts for a two card blackjack which are much higher than the standard payouts for a blackjack; and
dealing the player two cards from a set of gaming cards selected to have from 1 to 8 decks of 52 cards each after the player has placed bets on a conventional blackjack and the additional enhanced payout blackjack.

2. An apparatus and method as claimed in claim 1, wherein the enhanced payout is enhanced to 40-1 where the first two cards dealt to a player are a same suit two card blackjack.

3. An apparatus and method as claimed in claim 1, wherein the enhanced payout is enhanced to 15-1 where the first two cards dealt to a player are for a same colour but different suits two card blackjack.

4. An apparatus and method as claimed in claim 1, wherein the enhanced payout is enhanced to 10-1 where the first two cards dealt to a player are for a different suit and different colour two card blackjack.

5. A method and apparatus for providing a Blackjack player with an additional bet when betting on a conventional blackjack, said method including:
providing for a blackjack betting layout on a table or a sheet, which layout has in addition to a standard blackjack layout having conventional blackjack bet placement areas one or more additional bet placement areas adjacent the conventional bet placement areas so that a bet may be made by a Blackjack player in addition to the standard blackjack bet;
designating enhanced payouts for a two card blackjack which are much higher than the standard payouts for a blackjack; and
dealing the player two cards from a set of gaming cards selected to have from 1 to 8 decks of 52 cards each after the player has placed bets on a conventional blackjack and the additional enhanced payout blackjack.

6. A method and apparatus as claimed in claim 5, wherein the sheet is a sheet of material, plastics, or cardboard.
